(19) United States
(12) Patent Application Publication
(10) Pub. No.: US 2024/0106576 A1
(43) Pub. Date: Mar. 28, 2024

(54) METHOD AND DEVICE IN NODES USED FOR WIRELESS COMMUNICATION

(71) Applicants: Yang HU, Shanghai (CN); Xiaobo ZHANG, Shanghai (CN)

(72) Inventors: Yang HU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/244,309

(22) Filed: Sep. 11, 2023

(30) Foreign Application Priority Data
Sep. 22, 2022 (CN) 202211160030.X

(51) Int. Cl. H04L 1/1829; H04W 52/14; H04W 72/1273; H04W 72/232

(52) U.S. Cl. CPC H04L 1/1854; H04W 52/146; H04W 72/1273; H04W 72/232

(57) ABSTRACT

The present application discloses a method and a device in a node for wireless communications. A first receiver detects a first signaling on a first serving cell, the first signaling having a first-type DCI format, the first-type DCI format being used for scheduling PDSCH(s) on at most more than one serving cell; and a first transmitter, generates K HARQ-ACK bit(s) for scheduling of the first signaling; where the first serving cell is one of N serving cells, N being greater than 1, where each serving cell among the N serving cells is configured with the first-type DCI format; K is dependent on a configuration for the first-type DCI format on each serving cell among the N serving cells.

### CROSS REFERENCE TO RELATED APPLICATIONS

This application claims the priority benefit of Chinese Patent Application No. 202211160030.X, filed on Sep. 22, 2022, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

In a 5G NR system, with an aim to support Enhanced Mobile Broadband (eMBB), a large amount of Downlink Control Information (DCI) shall be transmitted to accomplish the scheduling of a physical-layer channel (such as a Physical Downlink Shared CHannel (PDSCH), or a Physical Uplink Shared CHannel (PUSCH)); using a single DCI to schedule multiple PDSCHs on multiple serving cells is an effective way of reducing the DCI overhead, so how to determine the number of corresponding Hybrid automatic repeat request acknowledgement (HARQ-ACK) bits is an important aspect that shall be taken into account.

### SUMMARY

To address the above problem, the present application provides a solution. It should be noted that although the statement above only took eMBB as an example; the present application is also applicable to other scenarios, for instance, Ultra-Reliable Low-Latency Communications (URLLC), V2X, IoT, Non-Terrestrial Networks (NTN), Multicast Broadcast Services (MBS), Extended Reality (XR), enhanced Machine-Type Communication (eMTC), and Full-Duplex Transmission, where similar technical effects can be achieved. Additionally, the adoption of a unified solution for various scenarios, including but not limited to eMBB, URLLC, V2X, IoT, NTN, MBS, XR, eMTC and Full-Duplex Transmission, contributes to the reduction of hardcore complexity and costs, or an enhancement in performance. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

In one embodiment, interpretations of the terminology in the present application refer to definitions given in the 3GPP T S36 series.

In one embodiment, interpretations of the terminology in the present application refer to definitions given in the 3GPP T S38 series.

In one embodiment, interpretations of the terminology in the present application refer to definitions given in the 3GPP T S37 series.

In one embodiment, interpretations of the terminology in the present application refer to definitions given in Institute of Electrical and Electronics Engineers (IEEE) protocol specifications.

The present application provides a method in a first node for wireless communications, comprising:
detecting a first signaling on a first serving cell, the first signaling having a first-type DCI format, the first-type DCI format being used for scheduling PDSCH(s) on at most more than one serving cell; and
generating K HARQ-ACK bit(s) for scheduling of the first signaling;
herein, the first serving cell is one of N serving cells, N being greater than 1, where each serving cell among the N serving cells is configured with the first-type DCI format; K is dependent on a configuration for the first-type DCI format on each serving cell among the N serving cells.

In one embodiment, an advantage of the above method includes: providing a HARQ-ACK feedback scheme applicable to the case in which a single DCI schedules configurations of multiple cells.

In one embodiment, an advantage of the above method includes: reducing the overhead of HARQ-ACK feedback.

In one embodiment, an advantage of the above method includes: increasing the chance of consistent understanding of HARQ-ACK feedback for both sides of communication.

In one embodiment, an advantage of the above method includes: enhancing the transmission performance of the uplink control signaling.

In one embodiment, an advantage of the above method includes: increasing the resource utilization ratio.

In one embodiment, an advantage of the above method includes: being easily compatible.

In one embodiment, an advantage of the above method includes: making only small modifications to the existing 3GPP specifications.

According to one aspect of the present application, the above method is characterized in that,
the first-type DCI format is monitored on each serving cell among the N serving cells.

According to one aspect of the present application, the above method is characterized in that,
the first-type DCI format is monitored on an active downlink BWP of each serving cell among the N serving cells.

According to one aspect of the present application, the above method is characterized in that,
a serving cell c is any serving cell among the N serving cells, and the first-type DCI format on the serving cell c is used for scheduling PDSCH(s) on at most more than one serving cell among K_{c} serving cells, K_{c} being greater than 1, where K depends on at least two serving cells among the K_{c} serving cells.

According to one aspect of the present application, the above method is characterized in that, a serving cell c is any serving cell among the N serving cells, and the first-type DCI format on the serving cell c is used for scheduling PDSCH(s) on at most K_{c} serving cells, K_{c} being greater than 1, where K depends on K_{c}.

According to one aspect of the present application, the above method is characterized in that,
a serving cell c is any serving cell among the N serving cells, and the first-type DCI format on the serving cell c is used for scheduling at most P_{c} PDSCHs, P_{c} being greater than 1, where K depends on P_{c}.

According to one aspect of the present application, the above method is characterized in that,
a serving cell c is any serving cell among the N serving cells, and the first-type DCI format on the serving cell c is used for scheduling at most M_{c} Transport Blocks (TBs), M_{c} being greater than 1, where K depends on M_{c}.

According to one aspect of the present application, the above method is characterized in that,
the K HARQ-ACK bit(s) is(are) transmitted.

According to one aspect of the present application, the above method is characterized in that,
at least the K HARQ-ACK bit(s) is(are) transmitted in a first PUCCH; a transmit power of the first PUCCH depends on K.

The present application provides a method in a second node for wireless communications, comprising:
transmitting a first signaling on a first serving cell, the first signaling having a first-type DCI format, the first-type DCI format being used for scheduling PDSCH(s) on at most more than one serving cell; and
receiving K HARQ-ACK bit(s) for scheduling of the first signaling;
herein, the first serving cell is one of N serving cells, N being greater than 1, where each serving cell among the N serving cells is configured with the first-type DCI format; K is dependent on a configuration for the first-type DCI format on each serving cell among the N serving cells.

According to one aspect of the present application, the above method is characterized in that,
a serving cell c is any serving cell among the N serving cells, and the first-type DCI format on the serving cell c is used for scheduling PDSCH(s) on at most more than one serving cell among K_{c} serving cells, K_{c} being greater than 1, where K depends on at least two serving cells among the K_{c} serving cells.

According to one aspect of the present application, the above method is characterized in that,
a serving cell c is any serving cell among the N serving cells, and the first-type DCI format on the serving cell c is used for scheduling PDSCH(s) on at most K_{c} serving cells, K_{c} being greater than 1, where K depends on K_{c}.

According to one aspect of the present application, the above method is characterized in that,
a serving cell c is any serving cell among the N serving cells, and the first-type DCI format on the serving cell c is used for scheduling at most P_{c} PDSCHs, P_{c} being greater than 1, where K depends on P_{c}.

According to one aspect of the present application, the above method is characterized in that,
a serving cell c is any serving cell among the N serving cells, and the first-type DCI format on the serving cell c is used for scheduling at most M_{c} Transport Blocks (TBs), M_{c} being greater than 1, where K depends on M_{c}.

According to one aspect of the present application, the above method is characterized in that,
at least the K HARQ-ACK bit(s) is(are) received in a first PUCCH; a transmit power of the first PUCCH depends on K.

The present application provides a first node for wireless communications, comprising:
a first receiver, detecting a first signaling on a first serving cell, the first signaling having a first-type DCI format, the first-type DCI format being used for scheduling PDSCH(s) on at most more than one serving cell; and
a first transmitter, generating K HARQ-ACK bit(s) for scheduling of the first signaling;
herein, the first serving cell is one of N serving cells, N being greater than 1, where each serving cell among the N serving cells is configured with the first-type DCI format; K is dependent on a configuration for the first-type DCI format on each serving cell among the N serving cells.

The present application provides a second node for wireless communications, comprising:
a second transmitter, transmitting a first signaling on a first serving cell, the first signaling having a first-type DCI format, the first-type DCI format being used for scheduling PDSCH(s) on at most more than one serving cell; and
a second receiver, receiving K HARQ-ACK bit(s) for scheduling of the first signaling;
herein, the first serving cell is one of N serving cells, N being greater than 1, where each serving cell among the N serving cells is configured with the first-type DCI format; K is dependent on a configuration for the first-type DCI format on each serving cell among the N serving cells.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of signal transmission according to one embodiment of the present application.

FIG. 6 illustrates a schematic diagram explaining K according to one embodiment of the present application.

FIG. 7 illustrates a schematic diagram explaining K according to one embodiment of the present application.

FIG. 8 illustrates a schematic diagram explaining K according to one embodiment of the present application.

FIG. 9 illustrates a schematic diagram explaining K according to one embodiment of the present application.

FIG. 10 illustrates a schematic diagram explaining a first PUCCH and a transmit power of the first PUCCH according to one embodiment of the present application.

FIG. 11 illustrates a schematic diagram of relations of a transmit power of a first PUCCH, a reference HARQ-ACK bit number and K according to one embodiment of the present application.

FIG. 12 illustrates a structure block diagram of a processing device in a first node according to one embodiment of the present application.

FIG. 13 illustrates a structure block diagram a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

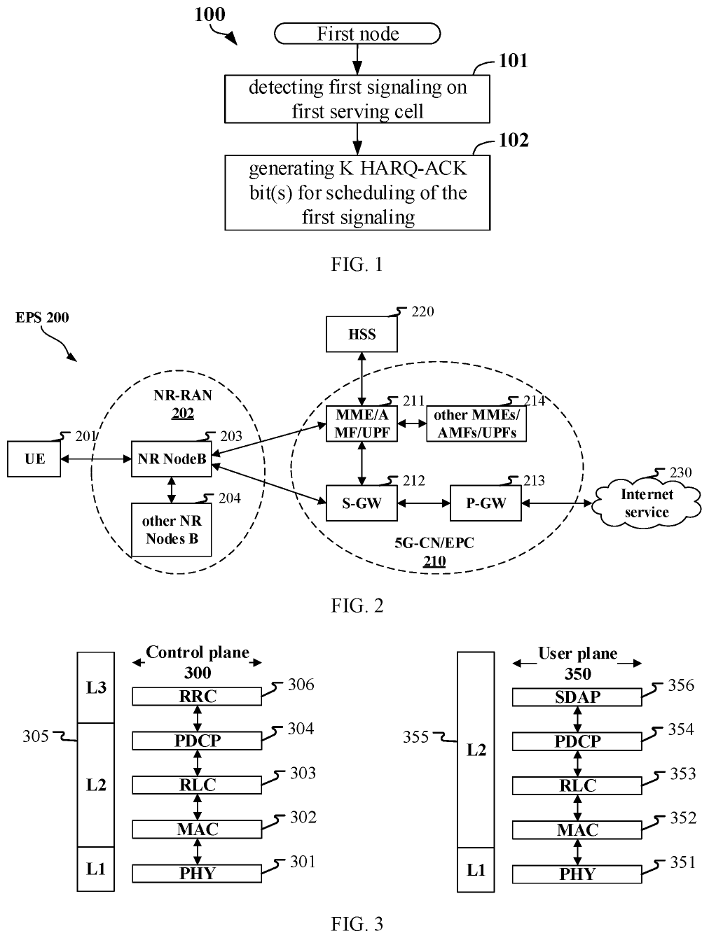

Embodiment 1 illustrates a flowchart of processing of a first node according to one embodiment of the present application, as shown in FIG. 1.

In Embodiment 1, the first node in the present application detects a first signaling on a first serving cell in step 101; and generates K HARQ-ACK bit(s) for scheduling of the first signaling in step 102.

In Embodiment 1, the first signaling has a first-type DCI format, the first-type DCI format being used for scheduling PDSCH(s) on at most more than one serving cell; the first serving cell is one of N serving cells, N being greater than 1, where each serving cell among the N serving cells is configured with the first-type DCI format; K is dependent on a configuration for the first-type DCI format on each serving cell among the N serving cells.

In one embodiment, the first serving cell is configurable.

In one embodiment, the first serving cell is a Primary cell (PCell).

In one embodiment, the first serving cell is a Secondary cell (SCell).

In one embodiment, the first serving cell is a Primary secondary cell (PSCell).

In one embodiment, the first serving cell is used for monitoring the first-type DCI format.

In one embodiment, the first-type DCI format is used for scheduling a PDSCH.

In one embodiment, the first-type DCI format is a DCI format for downlink scheduling.

In one embodiment, the first-type DCI format is configurable.

In one embodiment, the first-type DCI format is a DCI format 1_3.

In one embodiment, the first-type DCI format is a DCI format 1_4.

In one embodiment, the first-type DCI format is a DCI format 1_5.

In one embodiment, the first-type DCI format is a DCI format 1_6.

In one embodiment, the first-type DCI format is a DCI format 1_7.

In one embodiment, the first-type DCI format is a DCI format 1_8.

In one embodiment, the first-type DCI format is a DCI format 1_9.

In one embodiment, the first-type DCI format is a DCI format 1_10.

In one embodiment, the first-type DCI format is a DCI format 1_11.

In one embodiment, the first-type DCI format is a DCI format 1_12.

In one embodiment, the first-type DCI format includes at least one of a DCI format 1_3, a DCI format 1_4, a DCI format 1_5, a DCI format 1_6, a DCI format 1_7, a DCI format 1_8, a DCI format 1_9, a DCI format 1_10, a DCI format 1_11, or a DCI format 1_12.

In one embodiment, the first signaling is a DCI format 1_3.

In one embodiment, the first signaling is a DCI format 1_4.

In one embodiment, the first signaling is a DCI format 1_5.

In one embodiment, the first signaling is a DCI format 1_6.

In one embodiment, the first signaling is a DCI format 1_7.

In one embodiment, the first signaling is a DCI format 1_8.

In one embodiment, the first signaling is a DCI format 1_9.

In one embodiment, the first signaling is a DCI format 1_10.

In one embodiment, the first signaling is a DCI format 1_11.

In one embodiment, the first signaling is a DCI format 1_12.

In one embodiment, the first signaling is detected in a Physical Downlink Control Channel (PDCCH).

In one embodiment, the first signaling is detected in a PDCCH on the first serving cell.

In one embodiment, the first signaling comprises a PDCCH.

In one embodiment, the first signaling is a piece of Downlink Control Information (DCI).

In one embodiment, the first signaling is a physical layer signaling.

In one embodiment, the first signaling is used for scheduling a PDSCH.

In one embodiment, the first signaling is used for downlink scheduling.

In one embodiment, the statement that the first signaling has a first-type DCI format comprises that: a format of the first signaling is the first-type DCI format.

In one embodiment, the statement that the first signaling has a first-type DCI format comprises that: the first signaling uses the first-type DCI format.

In one embodiment, the statement that the first signaling has a first-type DCI format comprises that: the first-type DCI format is a DCI format 1_3, and the first signaling is a DCI format 1_3.

In one embodiment, the statement that the first signaling has a first-type DCI format comprises that: the first-type DCI format is a DCI format 1_4, and the first signaling is a DCI format 1_4.

In one embodiment, the statement that the first signaling has a first-type DCI format comprises that: the first-type DCI format is a DCI format 1_5, and the first signaling is a DCI format 1_5.

In one embodiment, the statement that the first signaling has a first-type DCI format comprises that: the first-type DCI format is a DCI format 1_X, and the first signaling is a DCI format 1_X, where X is one of 3, 4, 5, 6, 7, 8, 9, 10, 11, or 12.

In one embodiment, the statement of detecting a first signaling on a first serving cell, the first signaling having a first-type DCI format comprises: detecting a first-type DCI format on a first serving cell.

In one embodiment, the first-type DCI format on a serving cell is provided for the serving cell.

In one embodiment, the first-type DCI format on a serving cell is provided for a Bandwidth part (BWP) of the serving cell.

In one embodiment, the first-type DCI format on a serving cell is provided for an active BWP of the serving cell.

In one embodiment, the first-type DCI format on a serving cell is provided for an active Downlink (DL) BWP of the serving cell.

In one embodiment, the scheduling of the first signaling comprises: a Physical downlink shared channel (PDSCH) reception scheduled by the first signaling.

In one embodiment, the scheduling of the first signaling comprises: Transport Block(s) (TB(s)) in a PDSCH reception scheduled by the first signaling.

In one embodiment, the scheduling of the first signaling comprises: a serving cell scheduled by the first signaling.

In one embodiment, one of the K HARQ-ACK bit(s) indicates whether at least one TB in a PDSCH scheduled by the first signaling is correctly decoded.

In one embodiment, a value of one of the K HARQ-ACK bit(s) is set to 0.

In one embodiment, K is a positive integer.

In one embodiment, the statement “N serving cells” and the statement “multiple serving cells” have equivalent meaning or can be mutually replaced.

In one embodiment, the statement of the first-type DCI format being used for scheduling PDSCH(s) on at most more than one serving cell comprises that: the first-type DCI format on any serving cell among the N serving cells is used for scheduling PDSCH(s) on at most more than one serving cell.

In one embodiment, the statement of the first-type DCI format being used for scheduling PDSCH(s) on at most more than one serving cell comprises that: the first-type DCI format on any serving cell among the N serving cells is used for scheduling PDSCH(s) on one or multiple serving cells.

In one embodiment, the statement of the first-type DCI format being used for scheduling PDSCH(s) on at most more than one serving cell comprises that: the first-type DCI format on any serving cell among the N serving cells is used for scheduling PDSCHs on multiple serving cells.

In one embodiment, the statement of the first-type DCI format being used for scheduling PDSCH(s) on at most more than one serving cell comprises that: the first-type DCI format is used for scheduling PDSCHs on multiple serving cells.

In one embodiment, the statement of the first-type DCI format being used for scheduling PDSCH(s) on at most more than one serving cell comprises that: the first-type DCI format is used for scheduling PDSCH(s) on one or multiple serving cells.

In one embodiment, a serving cell c1 is one of the N serving cells, where the first-type DCI format on the serving cell c1 is used for scheduling a PDSCH on at most K_{c1} serving cells; a serving cell c2 is another one of the N serving cells, where the first-type DCI format on the serving cell c2 is used for scheduling PDSCH(s) on at most K_{c2} serving cells; K_{c1} is unequal to K_{c2}.

In one embodiment, a serving cell c1 is one of the N serving cells, where the first-type DCI format on the serving cell c1 is used for scheduling a PDSCH on at most K_{c1} serving cells; a serving cell c3 is another one of the N serving cells, where the first-type DCI format on the serving cell c3 is used for scheduling PDSCH(s) on at most K_{c3} serving cells; K_{c1} is equal to K_{c3}.

In one embodiment, the N serving cells are all scheduling cells.

In one embodiment, the N serving cells are configurable.

In one embodiment, the N serving cells are configured by an RRC signaling.

In one embodiment, the N serving cells are configured by a higher layer signaling.

In one embodiment, the statement that each serving cell among the N serving cells is configured with the first-type DCI format comprises that: the first node is configured to monitor the first-type DCI format on an active downlink BWP of each serving cell among the N serving cells.

In one embodiment, the statement that each serving cell among the N serving cells is configured with the first-type DCI format comprises that: based on configuration by a higher layer signaling, the first node monitors the first-type DCI format on each serving cell among the N serving cells.

In one embodiment, the higher layer signaling includes an RRC signaling.

In one embodiment, the higher layer signaling includes a MAC CE.

In one embodiment, the statement that each serving cell among the N serving cells is configured with the first-type DCI format comprises that: configuration of each serving cell among the N serving cells comprises configuration for the first-type DCI format.

In one embodiment, the statement that each serving cell among the N serving cells is configured with the first-type DCI format comprises that: configuration of an active downlink BWP of each serving cell among the N serving cells comprises configuration for the first-type DCI format.

In one embodiment, for the first node, each serving cell among the N serving cells is configured with the first-type DCI format.

In one embodiment, the statement that K is dependent on a configuration for the first-type DCI format on each serving cell among the N serving cells comprises that: a serving cell c is any serving cell among the N serving cells, and the first-type DCI format on the serving cell c is used for scheduling PDSCH(s) on at most more than one serving cell among K_{c} serving cells, K_{c} being greater than 1, where K depends on at least two serving cells among the K_{c} serving cells.

In one embodiment, the statement that K is dependent on a configuration for the first-type DCI format on each serving cell among the N serving cells comprises that: a serving cell c is any serving cell among the N serving cells, and the first-type DCI format on the serving cell c is used for scheduling PDSCH(s) on at most K_{c} serving cells, K_{c} being greater than 1, where K depends on K_{c}.

In one embodiment, the statement that K is dependent on a configuration for the first-type DCI format on each serving cell among the N serving cells comprises that: a serving cell c is any serving cell among the N serving cells, and the first-type DCI format on the serving cell c is used for scheduling at most P_{c} PDSCHs, P_{c} being greater than 1, where K depends on P_{c}.

In one embodiment, the statement that K is dependent on a configuration for the first-type DCI format on each serving cell among the N serving cells comprises that: a serving cell c is any serving cell among the N serving cells, and the first-type DCI format on the serving cell c is used for scheduling at most M_{c} Transport Blocks (TBs), M_{c} being greater than 1, where K depends on M_{c}.

In one embodiment, a serving cell c is any serving cell among the N serving cells, and the first-type DCI format on the serving cell c is used for scheduling at most P_{c} PDSCHs, where K depends on P_{c}.

In one embodiment, a serving cell c is any serving cell among the N serving cells, and the first-type DCI format on the serving cell c is used for scheduling at most M_{c} Transport Blocks (TBs), where K depends on M_{c}.

In one embodiment, the statement of detecting a first signaling on a first serving cell comprises: detecting the first signaling on an active DL BWP of the first serving cell.

In one embodiment, the statement of detecting a first signaling on a first serving cell comprises: frequency-domain resources occupied by the first signaling belonging to the first serving cell.

### Embodiment 2

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an Sl/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 corresponds to the second node in the present application.

In one embodiment, the UE 201 is a UE.

In one embodiment, the UE 201 is a UE supporting multicast transmission.

In one embodiment, the UE 201 is a normal UE.

In one embodiment, the gNB 203 corresponds to the first node in the present application.

In one embodiment, the gNB 203 corresponds to the second node in the present application.

In one embodiment, the UE 201 corresponds to the first node in the present application, and the gNB 203 corresponds to the second node in the present application.

In one embodiment, the gNB 203 is a MacroCellular base station.

In one embodiment, the gNB 203 is a Micro Cell base station.

In one embodiment, the gNB 203 is a PicoCell base station.

In one embodiment, the gNB 203 is a Femtocell.

In one embodiment, the gNB 203 is a base station supporting large time-delay difference.

In one embodiment, the gNB 203 is a flight platform.

In one embodiment, the gNB 203 is satellite equipment.

In one embodiment, the first node and the second node in the present application both correspond to the UE 201, for instance, V2X communications is performed between the first node and the second node.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between the first communication node and the second communication node or between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication nodes of the network side. The PDCP sublayer 304 provides multiplexing among variable radio bearers and logical channels. The PDCP sublayer 304 provides security by encrypting a packet and provides support for handover of a first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the PHY 301.

In one embodiment, the first PUCCH in the present application is generated by the PHY 301.

### Embodiment 4

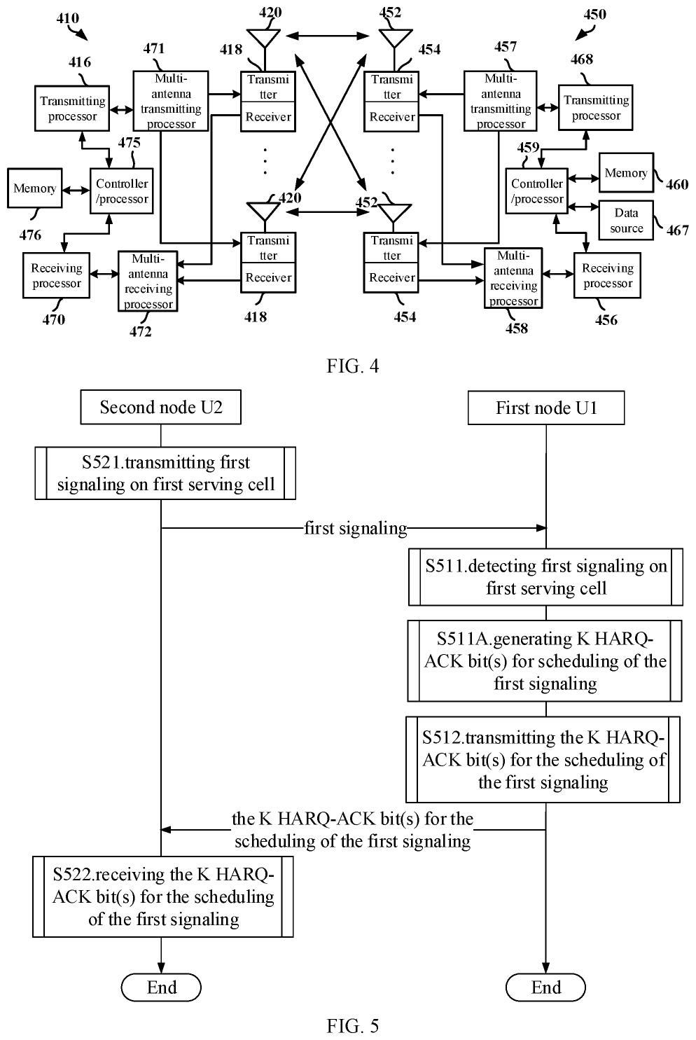

Embodiment 4 illustrates a schematic diagram of a first communication device and a second communication device according to the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In the transmission from the first communication device 410 to the second communication device 450, the controller/processor 475 provides header compression, encryption, packet segmentation and reordering, and multiplexing between a logical channel and a transport channel, and radio resource allocation of the second communication device 450 based on various priorities. The controller/processor 475 is also in charge of a retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any spatial stream targeting the second communication device 450. Symbols on each spatial stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication node 410 to the second communication node 450, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for a retransmission of a lost packet, and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission between the second communication device 450 and the first communication device 410, the controller/processor 475 provides de-multiplexing between a transport channel and a logical channel, packet reassembling, decrypting, header decompression, control signal processing so as to recover a higher-layer packet from the second communication device (UE) 450. The higher-layer packet coming from the controller/processor 475 may be provided to the core network.

In one embodiment, the first node in the present application comprises the second communication device 450, and the second node in the present application comprises the first communication device 410.

In one subembodiment, the first node is a UE, and the second node is a UE.

In one subembodiment, the first node is a UE, and the second node is a relay node.

In one subembodiment, the first node is a relay node, and the second node is a UE.

In one subembodiment, the first node is a UE, and the second node is a base station.

In one subembodiment, the first node is a relay node, and the second node is a base station.

In one subembodiment, the second node is a UE, and the first node is a base station.

In one subembodiment, the second node is a relay node, and the first node is a base station.

In one subembodiment, the second communication device 450 comprises: at least one controller/processor; the at least one controller/processor is in charge of HARQ operation.

In one subembodiment, the first communication device 410 comprises: at least one controller/processor; the at least one controller/processor is in charge of HARQ operation.

In one subembodiment, the first communication device 410 comprises: at least one controller/processor; the at least one controller/processor is in charge of error detections using ACK and/or NACK protocols to support HARQ operation.

In one embodiment, the second communication device 450 comprises at least one processor and at least one memory, the at least one memory comprises computer program codes; the at least one memory and the computer program codes are configured to be used in collaboration with the at least one processor. The second communication device 450 at least: detects a first signaling on a first serving cell, the first signaling having a first-type DCI format, the first-type DCI format being used for scheduling PDSCH(s) on at most more than one serving cell; and generates K HARQ-ACK bit(s) for scheduling of the first signaling; herein, the first serving cell is one of N serving cells, N being greater than 1, where each serving cell among the N serving cells is configured with the first-type DCI format; K is dependent on a configuration for the first-type DCI format on each serving cell among the N serving cells.

In one subembodiment, the second communication device 450 corresponds to the first node in the present application.

In one embodiment, the second communication device 450 comprises a memory that stores a computer readable instruction program, the computer readable instruction program generates actions when executed by at least one processor, which include: detecting a first signaling on a first serving cell, the first signaling having a first-type DCI format, the first-type DCI format being used for scheduling PDSCH(s) on at most more than one serving cell; and generating K HARQ-ACK bit(s) for scheduling of the first signaling; herein, the first serving cell is one of N serving cells, N being greater than 1, where each serving cell among the N serving cells is configured with the first-type DCI format; K is dependent on a configuration for the first-type DCI format on each serving cell among the N serving cells.

In one subembodiment, the second communication device 450 corresponds to the first node in the present application.

In one embodiment, the first communication device 410 comprises at least one processor and at least one memory, the at least one memory comprises computer program codes; the at least one memory and the computer program codes are configured to be used in collaboration with the at least one processor. The first communication device 410 at least: transmits a first signaling on a first serving cell, the first signaling having a first-type DCI format, the first-type DCI format being used for scheduling PDSCH(s) on at most more than one serving cell; and receives K HARQ-ACK bit(s) for scheduling of the first signaling; herein, the first serving cell is one of N serving cells, N being greater than 1, where each serving cell among the N serving cells is configured with the first-type DCI format; K is dependent on a configuration for the first-type DCI format on each serving cell among the N serving cells.

In one subembodiment, the first communication device 410 corresponds to the second node in the present application.

In one embodiment, the first communication device 410 comprises a memory that stores a computer readable instruction program, the computer readable instruction program generates actions when executed by at least one processor, which include: transmitting a first signaling on a first serving cell, the first signaling having a first-type DCI format, the first-type DCI format being used for scheduling PDSCH(s) on at most more than one serving cell; and receiving K HARQ-ACK bit(s) for scheduling of the first signaling; herein, the first serving cell is one of N serving cells, N being greater than 1, where each serving cell among the N serving cells is configured with the first-type DCI format; K is dependent on a configuration for the first-type DCI format on each serving cell among the N serving cells.

In one subembodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used for detecting the first-type DCI format in the present application.

In one embodiment, at least one of the antenna 452, the receiver 454, the multi-antenna receiving processor 458, the receiving processor 456, the controller/processor 459, the memory 460, or the data source 467 is used for detecting the first signaling in the present application.

In one embodiment, at least one of the antenna 420, the transmitter 418, the multi-antenna transmitting processor 471, the transmitting processor 416, the controller/processor 475 or the memory 476 is used for transmitting the first signaling in the present application.

In one embodiment, at least one of the antenna 452, the transmitter 454, the multi-antenna transmitting processor 458, the transmitting processor 468, the controller/processor 459, the memory 460 or the data source 467 is used for transmitting the K HARQ-ACK bit(s) in the present application.

In one embodiment, at least one of the antenna 420, the receiver 418, the multi-antenna receiving processor 472, the receiving processor 470, the controller/processor 475, or the memory 476 is used for receiving the K HARQ-ACK bit(s) in the present application.

### Embodiment 5

Embodiment 5 illustrates a flowchart of signal transmission according to one embodiment of the present application, as shown in FIG. 5. In FIG. 5, a first node U1 and a second node U2 are in communications via an air interface.

The first node U1 detects a first signaling on a first serving cell in step S511; generates K HARQ-ACK bit(s) for scheduling of the first signaling in step S511A; and transmits the K HARQ-ACK bit(s) for the scheduling of the first signaling in step S512.

The second node U2 transmits a first signaling on a first serving cell in step S521; and receives the K HARQ-ACK bit(s) for the scheduling of the first signaling in step S522.

In Embodiment 5, the first signaling has a first-type DCI format, the first-type DCI format being used for scheduling PDSCH(s) on at most more than one serving cell; the first serving cell is one of N serving cells, N being greater than 1, where each serving cell among the N serving cells is configured with the first-type DCI format; K is dependent on a configuration for the first-type DCI format on each serving cell among the N serving cells.

In one subembodiment of Embodiment 5, a serving cell c is any serving cell among the N serving cells, and the first-type DCI format on the serving cell c is used for scheduling PDSCH(s) on at most more than one serving cell among K_{c} serving cells, K_{c} being greater than 1, where K depends on at least two serving cells among the K_{c} serving cells.

In one subembodiment of Embodiment 5, a serving cell c is any serving cell among the N serving cells, and the first-type DCI format on the serving cell c is used for scheduling PDSCH(s) on at most K_{c} serving cells, K_{c} being greater than 1, where K depends on K_{c}.

In one subembodiment of Embodiment 5, a serving cell c is any serving cell among the N serving cells, and the first-type DCI format on the serving cell c is used for scheduling at most P_{c} PDSCHs, P_{c} being greater than 1, where K depends on P_{c}.

In one subembodiment of Embodiment 5, a serving cell c is any serving cell among the N serving cells, and the first-type DCI format on the serving cell c is used for scheduling at most M_{c} Transport Blocks (TBs), M_{c} being greater than 1, where K depends on M_{c}.

In one embodiment, the first node U1 is the first node in the present application.

In one embodiment, the second node U2 is the second node in the present application.

In one embodiment, the first node U1 is a UE.

In one embodiment, the first node U1 is a base station.

In one embodiment, the second node U2 is a base station.

In one embodiment, the second node U2 is a UE.

In one embodiment, an air interface between the second node U2 and the first node U1 is a Uu interface.

In one embodiment, an air interface between the second node U2 and the first node U1 includes a cellular link.

In one embodiment, an air interface between the second node U2 and the first node U1 is a PC5 interface.

In one embodiment, an air interface between the second node U2 and the first node U1 includes a sidelink.

In one embodiment, an air interface between the second node U2 and the first node U1 includes a radio interface between a base station and a UE.

In one embodiment, an air interface between the second node U2 and the first node U1 includes a radio interface between a satellite device and a UE.

In one embodiment, an air interface between the second node U2 and the first node U1 includes a radio interface between a UE and another UE.

In one embodiment, a problem to be solved in the present application includes: how to determine K.

In one embodiment, a problem to be solved in the present application includes: how to enhance the feedback performance of HARQ-ACK.

In one embodiment, a problem to be solved in the present application includes: how to process HARQ-ACK feedback with a single DCI format scheduling a PDSCH on multiple serving cells.

In one embodiment, a problem to be solved in the present application includes: how to optimize an uplink transmission of control signaling.

### Embodiment 6

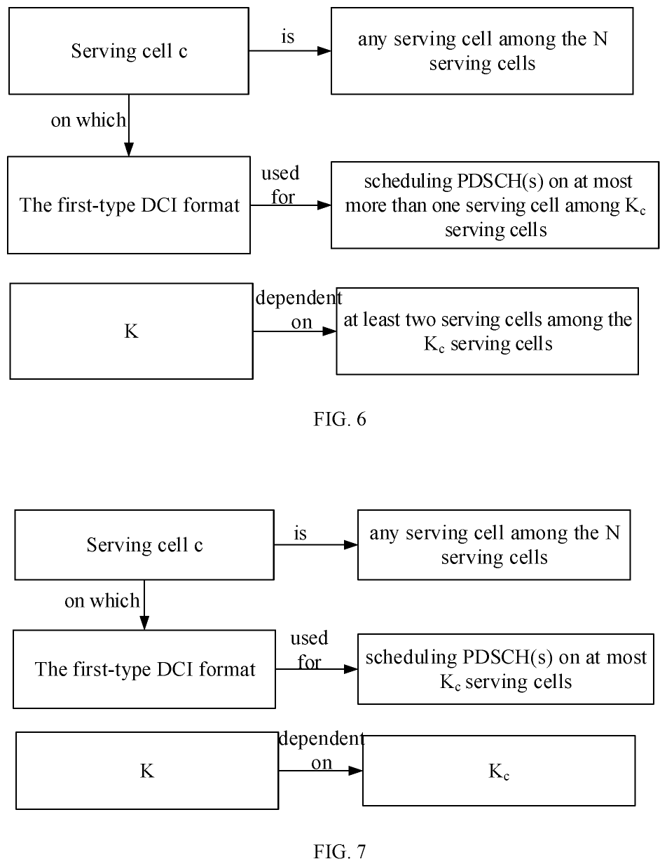

Embodiment 6 illustrates a schematic diagram explaining K according to one embodiment of the present application, as shown in FIG. 6.

In Embodiment 6, a serving cell c is any serving cell among the N serving cells, and the first-type DCI format on the serving cell c is used for scheduling PDSCH(s) on at most more than one serving cell among K_{c} serving cells, K_{c} being greater than 1, where K depends on at least two serving cells among the K_{c} serving cells.

In one embodiment, the serving cells are configurable.

In one embodiment, the K_{c} serving cells are configured by an RRC signaling.

In one embodiment, the K_{c} serving cells are configured by a higher layer signaling.

In one embodiment, the K_{c} serving cells are scheduled cells.

In one embodiment, K_{c} is configurable.

In one embodiment, K_{c} is configured by an RRC signaling.

In one embodiment, K_{c} is configured by a higher layer signaling.

In one embodiment, K_{c} is configured for the serving cell c.

In one embodiment, K_{c} is configured for the first-type DCI format on the serving cell c.

In one embodiment, K_{c} is no greater than 3.

In one embodiment, K_{c} is no greater than 4.

In one embodiment, K_{c} is no greater than 8.

In one embodiment, K_{c} is no greater than 32.

In one embodiment, K_{c} is equal to 3.

In one embodiment, K_{c} is equal to 4.

In one embodiment, c is a serving cell index of the serving cell c.

In one embodiment, the statement that K depends on at least two serving cells among the K_{c} serving cells comprises that: K depends on configuration on each serving cell of the at least two serving cells among the K_{c} serving cells.

In one embodiment, the statement that K depends on at least two serving cells among the K_{c} serving cells comprises that: K depends on configuration for a number of Codewords (CWs) on each serving cell of the at least two serving cells among the K_{c} serving cells.

In one embodiment, the statement that K depends on at least two serving cells among the K_{c} serving cells comprises that: K is equal to a maximum value of N values, among which a value depends on at least two serving cells among the K, serving cells.

In one embodiment, the statement that a value of the N values depends on at least two serving cells among the K_{c} serving cells comprises that: a value of the N values depends on configuration on each serving cell of the at least two serving cells among the K_{c} serving cells.

In one embodiment, the statement that a value of the N values depends on at least two serving cells among the K_{c} serving cells comprises that: a value of the N values depends on configuration for a number of Codewords (CWs) on each serving cell of the at least two serving cells among the serving cells.

In one embodiment, a value of the N values is equal to a sum of U_{c} values, among which each value is equal to a maximum number of Codewords (CWs) scheduled by a single DCI on an active Downlink (DL) BWP of one of U_{c} serving cells among the K_{c} serving cells, where U_{c} is a positive integer greater than 1 and no greater than K_{c}.

In one embodiment, a value of the N values is equal to a product of T and U_{c}, where T is no less than a maximum number of Codewords (CWs) scheduled by a single DCI on an active Downlink (DL) BWP of any of U_{c} serving cells among the K_{c} serving cells, where U_{c} is a positive integer greater than 1 and no greater than K_{c}.

In one embodiment, U_{c} is equal to K_{c}; the U_{c} serving cells among the K_{c} serving cells are: the K_{c} serving cells.

In one embodiment, U_{c} is less than K_{c}.

In one embodiment, U_{c} is configurable.

In one embodiment, the U_{c} serving cells are configurable.

In one embodiment, a serving cell c is any serving cell among the N serving cells, and the first-type DCI format on the serving cell c is used for scheduling PDSCH(s) on at most K_{c} serving cells, K_{c} being greater than 1, where a value of the N values depends on the K_{c} serving cells.

### Embodiment 7

Embodiment 7 illustrates a schematic diagram explaining K according to one embodiment of the present application, as shown in FIG. 7.

In Embodiment 7, a serving cell c is any serving cell among the N serving cells, and the first-type DCI format on the serving cell c is used for scheduling PDSCH(s) on at most K_{c} serving cells, K_{c} being greater than 1, where K depends on K_{c}.

In one embodiment, the statement that the first-type DCI format on the serving cell c is used for scheduling PDSCH(s) on at most serving cells comprises that: the first-type DCI format on the serving cell c is a DCI format configured for scheduling a PDSCH on at most K_{c} serving cells.

In one embodiment, the statement that K depends on K_{c} comprises that: K is equal to a maximum value of N values, among which a value depends on the K_{c}.

In one embodiment, the statement that K depends on K_{c} comprises that: K is equal to a maximum value of N values, among which a value is equal to the K_{c}.

In one embodiment, the statement that K depends on K_{c} comprises that: K is equal to a maximum value of N values, among which a value is equal to an integral multiple of the K_{c}.

In one embodiment, K is equal to a maximum value of N values, among which a value is equal to the K_{c}.

In one embodiment, K is equal to a maximum value of N values, among which a value is equal to an integral multiple of the K.

In one embodiment, the N values respectively correspond to the N serving cells.

### Embodiment 8

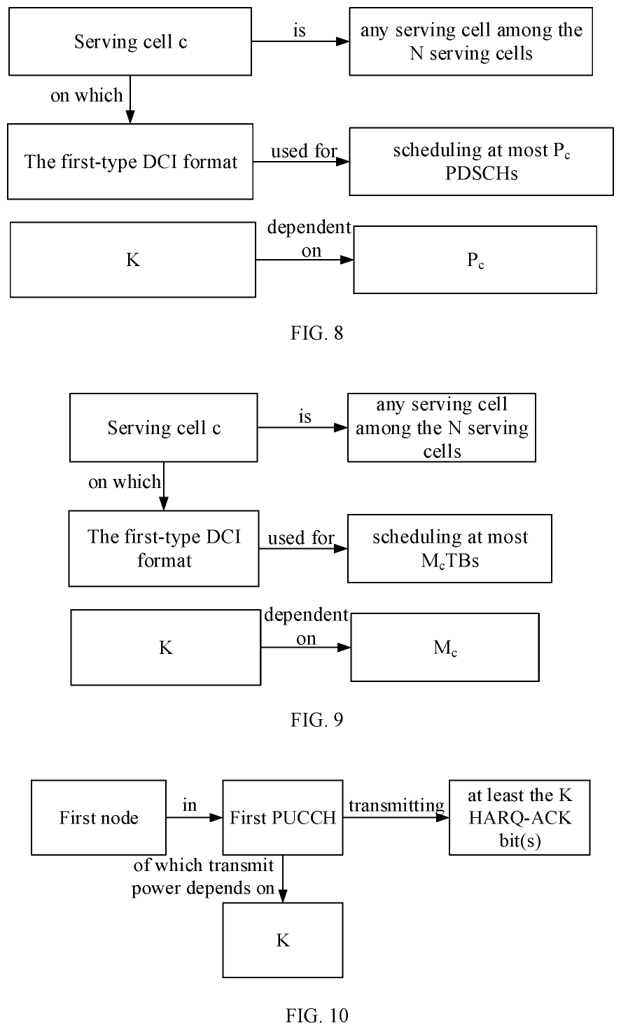

Embodiment 8 illustrates a schematic diagram explaining K according to one embodiment of the present application, as shown in FIG. 8.

In Embodiment 8, a serving cell c is any serving cell among the N serving cells, and the first-type DCI format on the serving cell c is used for scheduling at most P_{c} PDSCHs, P_{c} being greater than 1, where K depends on P_{c}.

In one embodiment, P_{c} is configurable.

In one embodiment, P_{c} is configured by an RRC signaling.

In one embodiment, P_{c} is configured by a higher layer signaling.

In one embodiment, the statement that K depends on P_{c} comprises that: K is equal to a maximum value of N values, of which a value depends on the P_{c}.

In one embodiment, the statement that K depends on P_{c} comprises that: K is equal to a maximum value of N values, of which a value is equal to the P_{c}.

In one embodiment, the statement that K depends on P_{c} comprises that: K is equal to a maximum value of N values, of which a value is equal to an integral multiple of the P_{c}.

In one embodiment, K is equal to a maximum value of N values, of which a value is equal to the P_{c}.

In one embodiment, K is equal to a maximum value of N values, of which a value is equal to an integral multiple of the P_{c}.

In one embodiment, the statement that the first-type DCI format on the serving cell c is used for scheduling at most P_{c} PDSCHs comprises that: a maximum number of PDSCHs scheduled by the first-type DCI format on the serving cell c is P_{c}.

### Embodiment 9

Embodiment 9 illustrates a schematic diagram explaining K according to one embodiment of the present application, as shown in FIG. 9.

In Embodiment 9, a serving cell c is any serving cell among the N serving cells, and the first-type DCI format on the serving cell c is used for scheduling at most M_{c} Transport Blocks (TBs), M_{c} being greater than 1, where K depends on M_{c}.

In one embodiment, M_{c} is configurable.

In one embodiment, M_{c} is configured by an RRC signaling.

In one embodiment, M_{c} is configured by a higher layer signaling.

In one embodiment, the statement that K depends on M_{c} comprises that: K is equal to a maximum value of N values, among which a value depends on the M_{c}.

In one embodiment, the statement that K depends on M_{c} comprises that: K is equal to a maximum value of N values, among which a value is equal to the M_{c}.

In one embodiment, the statement that K depends on M_{c} comprises that: K is equal to a maximum value of N values, among which a value is equal to an integral multiple of the M_{c}.

In one embodiment, K is equal to a maximum value of N values, among which a value is equal to the M_{c}.

In one embodiment, K is equal to a maximum value of N values, among which a value is equal to an integral multiple of the M_{c}.

In one embodiment, the statement that the first-type DCI format on the serving cell c schedules at most M_{c} TBs comprises that: a maximum number of TBs in PDSCHs scheduled by the first-type DCI format on the serving cell c is M_{c}.

In one embodiment, the statement that the first-type DCI format on the serving cell c schedules at most M_{c} TBs comprises that: a maximum number of CWs scheduled by the first-type DCI format on the serving cell c is M_{c}.

### Embodiment 10

Embodiment 10 illustrates a schematic diagram explaining a first PUCCH and a transmit power of the first PUCCH according to one embodiment of the present application, as shown in FIG. 10.

In Embodiment 10, the first node in the present application transmits at least the K HARQ-ACK bit(s) in a first PUCCH; a transmit power of the first PUCCH depends on K.

In one embodiment, the first Physical uplink control channel (PUCCH) is also used for transmitting an SR bit.

In one embodiment, the first PUCCH is also used for transmitting a CSI bit.

In one embodiment, the K HARQ-ACK bit(s), after having been through at least channel coding, is(are) transmitted in the first PUCCH.

In one embodiment, a HARQ-ACK Codebook that includes the K HARQ-ACK bit(s), after having been through at least Channel Coding, is transmitted in the first PUCCH.

In one embodiment, a HARQ-ACK Codebook that includes the K HARQ-ACK bit(s), after having been through at least part of Channel Coding, Scrambling, Modulation and Spreading, and Mapping to Physical Resources, is transmitted in the first PUCCH.

In one embodiment, a HARQ-ACK Codebook that includes the K HARQ-ACK bit(s), after having been through at least part of Channel Coding, Scrambling, Modulation, Block-wise spreading, Transform precoding, and Mapping to Physical Resources, is transmitted in the first PUCCH.

In one embodiment, a HARQ-ACK Codebook that includes the K HARQ-ACK bit(s), after having been through Sequence Generation and Mapping to Physical Resources, is transmitted in the first PUCCH.

In one embodiment, a HARQ-ACK Codebook that includes the K HARQ-ACK bit(s), after having been through Sequence Modulation and Mapping to Physical Resources, is transmitted in the first PUCCH.

### Embodiment 11

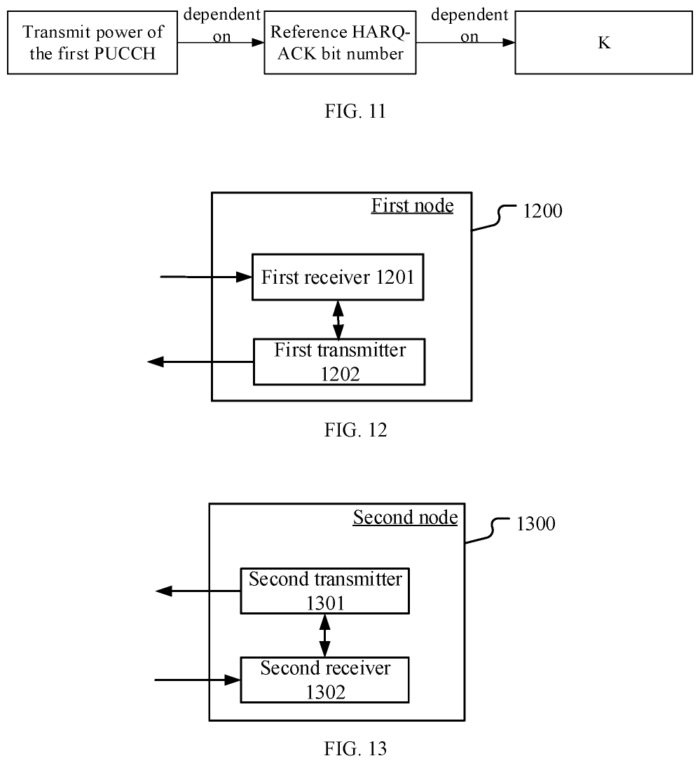

Embodiment 11 illustrates a schematic diagram of relations of a transmit power of a first PUCCH, a reference HARQ-ACK bit number and K according to one embodiment of the present application, as shown in FIG. 11.

In Embodiment 11, a transmit power of the first PUCCH depends on a reference HARQ-ACK bit number (i.e., bit size), the reference HARQ-ACK bit number depending on K.

In one embodiment, the reference HARQ-ACK bit number is a number of HARQ-ACK bit(s) for obtaining a PUCCH transmit power.

In one embodiment, K is used to determine the reference HARQ-ACK bit number.

In one embodiment, K is used to indicate the reference HARQ-ACK bit number.

In one embodiment, the reference HARQ-ACK bit number is linear with K.

In one embodiment, the reference HARQ-ACK bit number is equal to a sum of multiple values, where one of the multiple values is equal to a non-negative integral multiple of K.

In one embodiment, the reference HARQ-ACK bit number is equal to a sum of multiple values, where one of the multiple values is linear with K.

In one embodiment, the reference HARQ-ACK bit number is used to determine the transmit power of the first PUCCH.

In one embodiment, a first UCI bit number (i.e., bit size) is related to the reference HARQ-ACK bit number, and the first UCI bit number is used together with a first resource size for determining a target amount of adjustment.

In one embodiment, the first resource size is equal to a number of resource elements (REs) used for bearing UCI transmitted in the first PUCCH.

In one embodiment, the first resource size is a number of REs.

In one embodiment, the first resource size is no greater than a number of REs occupied by the first PUCCH.

In one embodiment, the first resource size is no greater than a number of REs comprised by a PUCCH resource to which resources occupied by the first PUCCH belong in time-frequency domain.

In one embodiment, the first resource size is a number of REs occupied by the first PUCCH.

In one embodiment, the first resource size is a number of REs occupied by the first PUCCH in time-frequency domain.

In one embodiment, the first resource size is a number of REs occupied by a transmission of the first PUCCH excluding RE(s) occupied by a Demodulation reference signal (DM-RS).

In one embodiment, the first resource size=M_{RB}×N_{sc}×N_{symbol}; the M_{RB} is equal to a number of resource blocks used for a transmission of the first PUCCH, N_{sc} is equal to a number of subcarrier(s) other than subcarrier(s) used for DM-RS transmission in each Resource Block (RB), and N_{symbol} is equal to a number of time-domain symbol(s) other than time-domain symbol(s) used for DM-RS transmission in the transmission of the first PUCCH.

In one embodiment, the meaning of the sentence that the first UCI bit number is used together with the first resource size for determining the target amount of adjustment includes: a second amount of calculation is equal to a product of K₁ and the first UCI bit number being divided by the first resource size, and the target amount of adjustment is equal to 10 multiplied by the logarithm of the second amount of calculation to the base 10, where K₁ is a constant or is configurable.

In one embodiment, the meaning of the sentence that the first UCI bit number is used together with the first resource size for determining the target amount of adjustment includes: a second amount of calculation is equal to a product of K₁ and the first UCI bit number being divided by the first resource size, and the target amount of adjustment=10×log₁₀ (the second amount of calculation), where K₁ is equal to 6.

In one embodiment, a second amount of calculation is equal to a product of K₁ and the first UCI bit number being divided by the first resource size, and the target amount of adjustment=10×log₁₀(the second amount of calculation), where K₁ is equal to 6.

In one embodiment, a second amount of calculation is equal to a product of K₂ and the first UCI bit number being divided by the first resource size, and the target amount of adjustment is equal to 10×log₁₀(2\hat{ }{the second amount of calculation}−1), where K₂ is pre-defined or is configurable.

In one embodiment, K₂ is greater than 0.

In one embodiment, K₂ is equal to 2.4.

In one embodiment, K₂ is -pre-defined.

In one embodiment, K₂ is configurable.

In one embodiment, a ratio of the first UCI bit number to the first resource size is used to determine the target amount of adjustment.

In one embodiment, the target amount of adjustment is linear with a product of the first UCI bit number and the first resource size.

In one embodiment, 10\hat{ }(the target amount of adjustment/10) is linear with {the first UCI bit number/the first resource size}.

In one embodiment, a ratio of the first UCI bit number to the first resource size is used to determine the target amount of adjustment.

In one embodiment, the first UCI bit number is equal to a sum of multiple HARQ-ACK bit numbers, with the reference HARQ-ACK bit number being one of the multiple HARQ-ACK bit numbers; each of the multiple HARQ-ACK bit numbers is a number of HARQ-ACK bit(s) determined for obtaining a transmit power of PUCCH.

In one embodiment, any of the multiple HARQ-ACK bit numbers is equal to a non-negative integer.

In one embodiment, the multiple HARQ-ACK bit numbers respectively correspond to different HARQ-ACK sub-codebooks.

In one embodiment, the first UCI bit number is equal to the reference HARQ-ACK bit number.

In one embodiment, the first UCI bit number is linear with the reference HARQ-ACK bit number.

In one embodiment, the reference HARQ-ACK bit number is one of multiple addends for obtaining the first UCI bit number.

In one embodiment, the first UCI bit number is equal to a sum of multiple UCI bit numbers, with the reference HARQ-ACK bit number being one of the multiple UCI bit numbers.

In one embodiment, the first UCI bit number is equal to a sum of multiple UCI bit numbers; a sum of multiple HARQ-ACK bit numbers is one of the multiple UCI bit numbers, with the reference HARQ-ACK bit number being one of the multiple HARQ-ACK bit numbers, where each of the multiple HARQ-ACK bit numbers is a number of HARQ-ACK bit(s) determined for obtaining a transmit power of PUCCH.

In one embodiment, any of the multiple UCI bit numbers is a number of a type of Uplink control information (UCI) bit(s).

In one embodiment, one of the multiple UCI bit numbers is a number of SR bit(s).

In one embodiment, one of the multiple UCI bit numbers is a number of CSI bit(s).

In one embodiment, the first UCI bit number is equal to a sum of the reference HARQ-ACK bit number, a number of Scheduling request (SR) bits carried by the first PUCCH and a number of Channel State Information (CSI) bits carried by the first PUCCH.

In one embodiment, the first UCI bit number is equal to a sum of multiple HARQ-ACK bit numbers plus a number of SR bits carried by the first PUCCH plus a number of CSI bits carried by the first PUCCH, where the reference HARQ-ACK bit number is one of the multiple HARQ-ACK bit numbers; each of the multiple HARQ-ACK bit numbers is a number of HARQ-ACK bit(s) determined for obtaining a transmit power of PUCCH.

In one embodiment, a number of SR bit(s) carried by the first PUCCH is equal to 0.

In one embodiment, a number of SR bit(s) carried by the first PUCCH is greater than 0.

In one embodiment, a number of CSI bit(s) carried by the first PUCCH is equal to 0.

In one embodiment, a number of CSI bit(s) carried by the first PUCCH is greater than 0.

In one embodiment, the target amount of adjustment is an adjustment component of a PUCCH transmit power.

In one embodiment, the reference HARQ-ACK bit number is used to determine a target amount of adjustment, the target amount of adjustment being used to determine the target transmit power.

In one embodiment, the reference HARQ-ACK bit number is used to indicate the target amount of adjustment.

In one embodiment, the reference HARQ-ACK bit number is used to explicitly indicate the target amount of adjustment.

In one embodiment, the reference HARQ-ACK bit number is used to implicitly indicate the target amount of adjustment.

In one embodiment, the reference HARQ-ACK bit number is used to calculate for obtaining the target amount of adjustment.

In one embodiment, the statement in the present application that “the reference HARQ-ACK bit number is used to determine a target amount of adjustment” comprises that: the reference HARQ-ACK bit number is used to determine a first UCI bit number, where the first UCI bit number is used together with a first resource size for determining a target amount of adjustment, the first resource size being no greater than a number of REs occupied by the first PUCCH.

In one embodiment, the target amount of adjustment is used for determining a target transmit power.

In one embodiment, the statement in the present application that “the target amount of adjustment is used for determining a target transmit power” comprises that: the target transmit power is equal to a sum of multiple power control components, with the target amount of adjustment being one of the multiple power control components.

In one embodiment, the statement in the present application that “the target amount of adjustment is used for determining a target transmit power” comprises that: the target transmit power is linear with the target amount of adjustment.

In one embodiment, the statement in the present application that “the target amount of adjustment is used for determining a target transmit power” comprises that: the target transmit power is linear with the target amount of adjustment in dB domain.

In one embodiment, the statement in the present application that “the target amount of adjustment is used for determining a target transmit power” comprises that: the target transmit power is directly proportional to the target amount of adjustment.

In one embodiment, the first transmit power in the present application is equal to a smaller value between the upper-limit transmit power and the target transmit power in the present application, where the target transmit power is a sum of multiple power control components, with a target amount of adjustment being one of the multiple power control components.

In one embodiment, the first transmit power in the present application is equal to a smaller value between the upper-limit transmit power and the target transmit power in the present application, where the target transmit power is a product of multiple power control components, with a target amount of adjustment being one of the multiple power control components.

In one embodiment, the first transmit power is equal to a smaller value between an upper-limit transmit power and a target transmit power, where the target transmit power is a sum of multiple power control components, with a target amount of adjustment being one of the multiple power control components.

In one embodiment, the first transmit power is the transmit power of the first PUCCH.

In one embodiment, that the target transmit power is equal to a sum of the multiple power control components is for dB domain.

In one embodiment, in terms of dB, the target transmit power is equal to a sum of the multiple power control components.

In one embodiment, a power control component among the multiple power control components is measured in dBm or dB.

In one embodiment, the upper-limit transmit power is default.

In one embodiment, the upper-limit transmit power is configurable.

In one embodiment, the upper-limit transmit power is configured by a higher-layer signaling.

In one embodiment, the upper-limit transmit power is configured by an RRC signaling.

In one embodiment, the upper-limit transmit power is a configured maximum output power.

In one embodiment, the upper-limit transmit power is provided for a PUCCH transmission occasion.

In one embodiment, the upper-limit transmit power is a UE configured maximum output power for a carrier in a PUCCH transmission occasion.

In one embodiment, a symbol indicating the upper-limit transmit power includes P_{CMAX,f}.

In one embodiment, the upper-limit transmit power is measured in dBm.

In one embodiment, the upper-limit transmit power is measured in Watts (W).

In one embodiment, the upper-limit transmit power is measured in milli-Watts (mW).

In one embodiment, the first transmit power is equal to min{upper-limit transmit power, target transmit power}.

In one embodiment, the first transmit power is equal to a smaller value between an upper-limit transmit power and a target transmit power, where the target transmit power is linear with the target amount of adjustment, and the upper-limit transmit power is default or configurable.

In one embodiment, the target transmit power is linear with the target amount of adjustment.

In one embodiment, the linear relation between the target transmit power and the target amount of adjustment refers to that the target transmit power and the target amount of adjustment are linear with each other in dB domain.

In one embodiment, the linear relation between the target transmit power and the target amount of adjustment refers to that the target transmit power and the target amount of adjustment are linear with each other in terms of dB.

In one embodiment, the target transmit power is measured in dBm, and the target amount of adjustment is measured in dB.

In one embodiment, the target transmit power is equal to a sum of a target amount of adjustment plus other power control component(s), where one power control component of the other power control component(s) is configurable or related to the first PUCCH or obtained based on indication.

In one embodiment, in terms of dB, the target transmit power is equal to a sum of multiple power control components, the multiple power control components including the target amount of adjustment and other power control component(s), the other power control component(s) including at least one of a first power control component, a second power control component, a third power control component, a fourth power control component or a fifth power control component.

In one embodiment, the target transmit power is equal to a sum of multiple power control components, the multiple power control components including the target amount of adjustment and other power control component(s), the other power control component(s) including at least one of a first power control component, a second power control component, a third power control component, a fourth power control component or a fifth power control component.

In one embodiment, the first transmit power is equal to a smaller value between an upper-limit transmit power and a target transmit power, where the target transmit power is a product of multiple power control components, with the target amount of adjustment in the present application being one of the multiple power control components; the upper-limit transmit power is default or configurable.

In one embodiment, the first transmit power is equal to a smaller value between an upper-limit transmit power and a target transmit power, where the target transmit power is directly proportional to the target amount of adjustment, and the upper-limit transmit power is default or configurable.

In one embodiment, the target transmit power is equal to a product of multiple power control components, the multiple power control components including the target amount of adjustment and other power control component(s), the other power control component(s) including at least one of a first power control component, a second power control component, a third power control component, a fourth power control component or a fifth power control component.

In one embodiment, the other power control component(s) includes/include at least one power control component.

In one embodiment, the other power control components include multiple power control components.

In one embodiment, one of the other power control component(s) is defined in 3GPP TS38.213, Section 7.2.1.

In one embodiment, the other power control components include at least one of a first power control component, a second power control component, a third power control component, a fourth power control component or a fifth power control component.

In one embodiment, the target transmit power is equal to a sum of the target amount of adjustment, a first power control component, a second power control component, a third power control component, a fourth power control component and a fifth power control component.

In one embodiment, a p0-nominal field is used for configuring the first power control component.

In one embodiment, a P0-PUCCH field is used for configuring the first power control component.

In one embodiment, a p0-PUCCH-Value field is used for configuring the first power control component.

In one embodiment, the first power control component is equal to 0.

In one embodiment, the first power control component is measured in dBm.

In one embodiment, the first power control component is measured in Watts (W).

In one embodiment, the first power control component is measured in milli-Watts (mW).

In one embodiment, symbols in which the first power control component is expressed include P_{O_PUCCH,b,f,c}.

In one embodiment, symbols in which the first power control component is expressed include O_PUCCH.

In one embodiment, the first power control component is equal to a sum of two sub-components, of which any component is a default value or configured by an RRC signaling.

In one embodiment, the first power control component is equal to a sum of two sub-components, of which one is a p0-PUCCH-Value or equal to 0 and the other is configured in a p0-nominal field or equal to 0 dBm.

In one embodiment, the first power control component is configurable.

In one embodiment, the first PUCCH is used to determine the second power control component.

In one embodiment, frequency-domain resources occupied by the first PUCCH are used to determine the second power control component.

In one embodiment, the second power control component is equal to 10×log₁₀(2\hat{ }μ×M_{RB}), where the M_{RB} is equal to a number of Resource Block(s) (RB(s)) comprised by all or part of PUCCH resources to which resources occupied by the first PUCCH belong in frequency domain, and the μ is a Subcarrier spacing (SCS) configuration.

In one embodiment, the second power control component is equal to 10×log₁₀(2\hat{ }μ×M_{RB}), where the M_{RB} is equal to a number of Resource Block(s) (RB(s)) comprised by resources occupied by the first PUCCH in frequency domain, and the μ is a Subcarrier spacing (SCS) configuration.

In one embodiment, the second power control component is equal to 2\hat{ }μ×M_{RB}, where the M_{RB} is equal to a number of Resource Block(s) (RB(s)) comprised by resources occupied by the first PUCCH in frequency domain, and the μ is a Subcarrier spacing (SCS) configuration.

In one embodiment, μ is configurable.

In one embodiment, the third power control component is a downlink pathloss estimate.

In one embodiment, the third power control component is measured in dB.

In one embodiment, the third power control component is obtained by calculation based on a measurement for a reference signal.

In one embodiment, symbols in which the third power control component is expressed include PL_{b,f,c}.

In one embodiment, symbols in which the third power control component is expressed include PL.

In one embodiment, the third power control component is measured in Watts (W).

In one embodiment, the third power control component is measured in milli-Watts (mW).

In one embodiment, the fourth power control component is one of a value of deltaF-PUCCH-f2, a value of deltaF-PUCCH-f3, a value of deltaF-PUCCH-f4 or 0.

In one embodiment, the fourth power control component is equal to a default value or is configured by an RRC signaling.

In one embodiment, the fourth power control component is related to a PUCCH format.

In one embodiment, the fourth power control component is related to a PUCCH format used by the first PUCCH.

In one embodiment, the first PUCCH uses one of a PUCCH format 2, or a PUCCH format 3 or a PUCCH format 4; when the first PUCCH uses a PUCCH format 2, the fourth power control component is a value of deltaF-PUCCH-f2 or 0; when the first PUCCH uses a PUCCH format 2, the fourth power control component is a value of deltaF-PUCCH-f3 or 0; when the first PUCCH uses a PUCCH format 2, the fourth power control component is a value of deltaF-PUCCH-f4 or 0.

In one embodiment, symbols in which the fourth power control component is expressed include Δ_{F_PUCCH}.

In one embodiment, symbols in which the fourth power control component is expressed include F_PUCCH.

In one embodiment, the fifth power control component is a PUCCH power control adjustment state.

In one embodiment, the fifth power control component is obtained based on an indication by a TPC field in a DCI format.

In one embodiment, the fifth power control component is determined based on a Transmit power control (TPC) command.

In one embodiment, a value of the fifth power control component is for a PUCCH transmission occasion corresponding to the first PUCCH.

In one embodiment, a field of TPC command for scheduled PUCCH in the first signaling is used to determine the fifth power control component.

In one embodiment, in terms of dB, the fifth power control component is linear with a value indicated by a field of TPC command for scheduled PUCCH in the first signaling.

In one embodiment, symbols in which the fifth power control component is expressed include g_{b,t,c}.

In one embodiment, symbols in which the target amount of adjustment is expressed include Δ.

In one embodiment, symbols in which the target amount of adjustment is expressed include Δ_{TF,b,f,c}.

In one embodiment, one of a PUCCH format 2 or a PUCCH format 3 or a PUCCH format 4 is used for the first PUCCH.

In one embodiment, one of a PUCCH format 3 or a PUCCH format 4 is used for the first PUCCH.

In one embodiment, the first PUCCH also occupies a code-domain resource.

### Embodiment 12

Embodiment 12 illustrates a structure block diagram of a processing device in a first node, as shown in FIG. 12. In FIG. 12, a processing device 1200 in a first node is comprised of a first receiver 1201 and a first transmitter 1202.

In one embodiment, the first node 1200 is a base station.

In one embodiment, the first node 1200 is a UE.

In one embodiment, the first node 1200 is a relay node.

In one embodiment, the first node 1200 is vehicle-mounted communication equipment.

In one embodiment, the first node 1200 is a UE supporting V2X communications.

In one embodiment, the first node 1200 is a relay node supporting V2X communications.

In one embodiment, the first node 1200 is a UE supporting operations on high-frequency spectrum.

In one embodiment, the first node 1200 is a UE supporting operations on shared spectrum.

In one embodiment, the first node 1200 is a UE supporting XR services.

In one embodiment, the first node 1200 is a UE supporting multicast transmission.

In one embodiment, the first receiver 1201 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1201 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1202 comprises at least one of the antenna 452, the transmitter 454, the multi-antenna transmitting processor 457, the transmitting processor 468, the controller/processor 459, the memory 460 or the data source 467 in FIG. 4 of the present application.

In one embodiment, the first transmitter 1202 comprises at least the first five of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1202 comprises at least the first four of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1202 comprises at least the first three of the antenna 452, the transmitter 454, the multi-antenna transmitting processor 457, the transmitting processor 468, the controller/processor 459 the memory 460 and the data source 467 in FIG. 4 of the present application.

In one embodiment, the first transmitter 1202 comprises at least the first two of the antenna 452, the transmitter 454, the multi-antenna transmitting processor 457, the transmitting processor 468, the controller/processor 459, the memory 460 and the data source 467 in FIG. 4 of the present application.

In one embodiment, the first receiver 1201 detects a first signaling on a first serving cell, the first signaling having a first-type DCI format, the first-type DCI format being used for scheduling PDSCH(s) on at most more than one serving cell; and the first transmitter 1202 generates K HARQ-ACK bit(s) for scheduling of the first signaling; herein, the first serving cell is one of N serving cells, N being greater than 1, where each serving cell among the N serving cells is configured with the first-type DCI format; K is dependent on a configuration for the first-type DCI format on each serving cell among the N serving cells.

In one embodiment, the first receiver 1201 monitors the first-type DCI format on each serving cell among the N serving cells.

In one embodiment, the first receiver 1201 monitors the first-type DCI format on an active downlink BWP of each serving cell among the N serving cells.

In one embodiment, a serving cell c is any serving cell among the N serving cells, and the first-type DCI format on the serving cell c is used for scheduling PDSCH(s) on at most more than one serving cell among K_{c} serving cells, K_{c} being greater than 1, where K depends on at least two serving cells among the K_{c} serving cells.

In one embodiment, a serving cell c is any serving cell among the N serving cells, and the first-type DCI format on the serving cell c is used for scheduling PDSCH(s) on at most K_{c} serving cells, K_{c} being greater than 1, where K depends on K_{c}.

In one embodiment, a serving cell c is any serving cell among the N serving cells, and the first-type DCI format on the serving cell c is used for scheduling at most P_{c} PDSCHs, P_{c} being greater than 1, where K depends on P_{c}.

In one embodiment, a serving cell c is any serving cell among the N serving cells, and the first-type DCI format on the serving cell c is used for scheduling at most M_{c} Transport Blocks (TBs), M_{c} being greater than 1, where K depends on M_{c}.

In one embodiment, the first transmitter 1202 transmits the K HARQ-ACK bit(s).

In one embodiment, the first transmitter 1202 transmits at least the K HARQ-ACK bit(s) in a first PUCCH; a transmit power of the first PUCCH depends on K.

### Embodiment 13

Embodiment 13 illustrates a structure block diagram a processing device in a second node according to one embodiment of the present application, as shown in FIG. 13. In FIG. 13, a processing device 1300 in a second node is comprised of a second transmitter 1301 and a second receiver 1302.

In one embodiment, the second node 1300 is a UE.

In one embodiment, the second node 1300 is a base station.

In one embodiment, the second node 1300 is satellite equipment.

In one embodiment, the second node 1300 is a relay node.

In one embodiment, the second node 1300 is vehicle-mounted communication equipment.

In one embodiment, the second node 1300 is UE supporting V2X communications.

In one embodiment, the second node 1300 is a device supporting operations on high-frequency spectrum.

In one embodiment, the second node 1300 is a device supporting operations on shared spectrum.

In one embodiment, the second node 1300 is a device supporting XR services.

In one embodiment, the second node 1300 is one piece of test apparatus, test equipment or test instrument.

In one embodiment, the second transmitter 1301 comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1301 comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1302 comprises at least one of the antenna 420, the receiver 418, the multi-antenna receiving processor 472, the receiving processor 470, the controller/processor 475 or the memory 476 in FIG. 4 of the present application.

In one embodiment, the second receiver 1302 comprises at least the first five of the antenna 420, the receiver 418, the multi-antenna receiving processor 472, the receiving processor 470, the controller/processor 475 and the memory 476 in FIG. 4 of the present application.

In one embodiment, the second receiver 1302 comprises at least the first four of the antenna 420, the receiver 418, the multi-antenna receiving processor 472, the receiving processor 470, the controller/processor 475 and the memory 476 in FIG. 4 of the present application.

In one embodiment, the second receiver 1302 comprises at least the first three of the antenna 420, the receiver 418, the multi-antenna receiving processor 472, the receiving processor 470, the controller/processor 475 and the memory 476 in FIG. 4 of the present application.

In one embodiment, the second receiver 1302 comprises at least the first two of the antenna 420, the receiver 418, the multi-antenna receiving processor 472, the receiving processor 470, the controller/processor 475 and the memory 476 in FIG. 4 of the present application.

In one embodiment, the second transmitter 1301 transmits a first signaling on a first serving cell, the first signaling having a first-type DCI format, the first-type DCI format being used for scheduling PDSCH(s) on at most more than one serving cell; and the second receiver 1302 receives K HARQ-ACK bit(s) for scheduling of the first signaling; herein, the first serving cell is one of N serving cells, N being greater than 1, where each serving cell among the N serving cells is configured with the first-type DCI format; K is dependent on a configuration for the first-type DCI format on each serving cell among the N serving cells.

In one embodiment, a serving cell c is any serving cell among the N serving cells, and the first-type DCI format on the serving cell c is used for scheduling PDSCH(s) on at most more than one serving cell among K_{c} serving cells, K_{c} being greater than 1, where K depends on at least two serving cells among the K_{c} serving cells.

In one embodiment, a serving cell c is any serving cell among the N serving cells, and the first-type DCI format on the serving cell c is used for scheduling PDSCH(s) on at most K_{c} serving cells, K_{c} being greater than 1, where K depends on K_{c}.

In one embodiment, a serving cell c is any serving cell among the N serving cells, and the first-type DCI format on the serving cell c is used for scheduling at most P_{c} PDSCHs, P_{c} being greater than 1, where K depends on P_{c}.

In one embodiment, a serving cell c is any serving cell among the N serving cells, and the first-type DCI format on the serving cell c is used for scheduling at most M_{c} Transport Blocks (TBs), M_{c} being greater than 1, where K depends on M_{c}.

In one embodiment, the second receiver 1302 receives at least the K HARQ-ACK bit(s) in a first PUCCH; a transmit power of the first PUCCH depends on K.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The base station in the present application includes but is not limited to macro-cellular base stations, micro-cellular base stations, home base stations, relay base station, eNB, gNB, Transmitter Receiver Point (TRP), GNSS, relay satellite, satellite base station, airborne base station, test apparatus, test equipment or test instrument, and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, detecting a first signaling on a first serving cell, the first signaling having a first-type DCI format, the first-type DCI format being used for scheduling PDSCH(s) on at most more than one serving cell; and
a first transmitter, generating K HARQ-ACK bit(s) for scheduling of the first signaling;
wherein the first serving cell is one of N serving cells, N being greater than 1, where each serving cell among the N serving cells is configured with the first-type DCI format; K is dependent on a configuration for the first-type DCI format on each serving cell among the N serving cells.

2. The first node according to claim 1, characterized in that the first receiver monitors the first-type DCI format on each serving cell among the N serving cells.

3. The first node according to claim 1, characterized in that a serving cell c is any serving cell among the N serving cells, and the first-type DCI format on the serving cell c is used for scheduling PDSCH(s) on at most more than one serving cell among K_{c} serving cells, K_{c} being greater than 1, where K depends on at least two serving cells among the K_{c} serving cells;
or, characterized in that a serving cell c is any serving cell among the N serving cells, and the first-type DCI format on the serving cell c is used for scheduling PDSCH(s) on at most K_{c} serving cells, K_{c} being greater than 1, where K depends on K_{c};
or, characterized in that a serving cell c is any serving cell among the N serving cells, and the first-type DCI format on the serving cell c is used for scheduling at most P_{c} PDSCHs, P_{c} being greater than 1, where K depends on P_{c}.

4. The first node according to claim 1, characterized in that a serving cell c is any serving cell among the N serving cells, and the first-type DCI format on the serving cell c is used for scheduling at most M_{c} Transport Blocks (TBs), M_{c} being greater than 1, where K depends on M_{c}.

5. The first node according to claim 4, characterized in that K is equal to a maximum value among N values, where one of the N values is equal to M_{c}.

6. The first node according to claim 4, characterized in that the first transmitter transmits at least the K HARQ-ACK bit(s) in a first PUCCH; a transmit power of the first PUCCH depends on K.

7. The first node according to claim 6, characterized in that the transmit power of the first PUCCH depends on a reference HARQ-ACK bit number (i.e., bit size), the reference HARQ-ACK bit number being a number of HARQ-ACK bit(s) for obtaining a PUCCH transmit power, where the reference HARQ-ACK bit number depends on K; a first transmit power is the transmit power of the first PUCCH, the first transmit power being equal to a smaller value between an upper-limit transmit power and a target transmit power; the reference HARQ-ACK bit number is used to determine a target adjustment, the target adjustment being used to determine the target transmit power, the target transmit power being equal to a sum of multiple power control components, where the target adjustment is one of the multiple power control components; the upper-limit transmit power is a configured maximum output power.

8. A second node for wireless communications, comprising:
a second transmitter, transmitting a first signaling on a first serving cell, the first signaling having a first-type DCI format, the first-type DCI format being used for scheduling PDSCH(s) on at most more than one serving cell; and
a second receiver, receiving K HARQ-ACK bit(s) for scheduling of the first signaling;
wherein the first serving cell is one of N serving cells, N being greater than 1, where each serving cell among the N serving cells is configured with the first-type DCI format; K is dependent on a configuration for the first-type DCI format on each serving cell among the N serving cells.

9. The second node according to claim 8, characterized in that a serving cell c is any serving cell among the N serving cells, and the first-type DCI format on the serving cell c is used for scheduling PDSCH(s) on at most more than one serving cell among K_{c} serving cells, K_{c} being greater than 1, where K depends on at least two serving cells among the K_{c} serving cells;
or, characterized in that a serving cell c is any serving cell among the N serving cells, and the first-type DCI format on the serving cell c is used for scheduling PDSCH(s) on at most K_{c} serving cells, K_{c} being greater than 1, where K depends on K_{c};
or, characterized in that a serving cell c is any serving cell among the N serving cells, and the first-type DCI format on the serving cell c is used for scheduling at most P_{c} PDSCHs, P_{c} being greater than 1, where K depends on P_{c}.

10. The second node according to claim 8, characterized in that a serving cell c is any serving cell among the N serving cells, and the first-type DCI format on the serving cell c is used for scheduling at most M_{c} TBs, M_{c} being greater than 1, where K depends on M_{c}.

11. The second node according to claim 10, characterized in that K is equal to a maximum value among N values, where one of the N values is equal to M_{c}.

12. The second node according to claim 10, characterized in that the second receiver receives at least the K HARQ-ACK bit(s) in a first PUCCH; a transmit power of the first PUCCH depends on K.

13. The second node according to claim 12, characterized in that the transmit power of the first PUCCH depends on a reference HARQ-ACK bit number (i.e., bit size), the reference HARQ-ACK bit number being a number of HARQ-ACK bit(s) for obtaining a PUCCH transmit power, where the reference HARQ-ACK bit number depends on K; a first transmit power is the transmit power of the first PUCCH, the first transmit power being equal to a smaller value between an upper-limit transmit power and a target transmit power; the reference HARQ-ACK bit number is used to determine a target adjustment, the target adjustment being used to determine the target transmit power, the target transmit power being equal to a sum of multiple power control components, where the target adjustment is one of the multiple power control components; the upper-limit transmit power is a configured maximum output power.

14. A method in a first node for wireless communications, comprising:
detecting a first signaling on a first serving cell, the first signaling having a first-type DCI format, the first-type DCI format being used for scheduling PDSCH(s) on at most more than one serving cell; and
generating K HARQ-ACK bit(s) for scheduling of the first signaling;
wherein the first serving cell is one of N serving cells, N being greater than 1, where each serving cell among the N serving cells is configured with the first-type DCI format; K is dependent on a configuration for the first-type DCI format on each serving cell among the N serving cells.

15. The method in the first node according to claim 14, characterized in:
monitoring the first-type DCI format on each serving cell among the N serving cells.

16. The method in the first node according to claim 14, characterized in that a serving cell c is any serving cell among the N serving cells, and the first-type DCI format on the serving cell c is used for scheduling PDSCH(s) on at most more than one serving cell among K_{c} serving cells, K_{c} being greater than 1, where K depends on at least two serving cells among the K_{c} serving cells;
or, characterized in that a serving cell c is any serving cell among the N serving cells, and the first-type DCI format on the serving cell c is used for scheduling PDSCH(s) on at most K_{c} serving cells, K_{c} being greater than 1, where K depends on K_{c};
or, characterized in that a serving cell c is any serving cell among the N serving cells, and the first-type DCI format on the serving cell c is used for scheduling at most P_{c} PDSCHs, P_{c} being greater than 1, where K depends on P_{c}.

17. The method in the first node according to claim 14, characterized in that a serving cell c is any serving cell among the N serving cells, and the first-type DCI format on the serving cell c is used for scheduling at most M_{c} TBs, M_{c} being greater than 1, where K depends on M_{c}.

18. The method in the first node according to claim 17, characterized in that K is equal to a maximum value among N values, where one of the N values is equal to M_{c}.

19. The method in the first node according to claim 17, characterized in that at least the K HARQ-ACK bit(s) is(are) transmitted in a first PUCCH; a transmit power of the first PUCCH depends on K.

20. The method in the first node according to claim 19, characterized in that the transmit power of the first PUCCH depends on a reference HARQ-ACK bit number (i.e., bit size), the reference HARQ-ACK bit number being a number of HARQ-ACK bit(s) for obtaining a PUCCH transmit power, where the reference HARQ-ACK bit number depends on K; a first transmit power is the transmit power of the first PUCCH, the first transmit power being equal to a smaller value between an upper-limit transmit power and a target transmit power; the reference HARQ-ACK bit number is used to determine a target adjustment, the target adjustment being used to determine the target transmit power, the target transmit power being equal to a sum of multiple power control components, where the target adjustment is one of the multiple power control components; the upper-limit transmit power is a configured maximum output power.
